(19) United States
(12) Patent Application Publication
(10) Pub. No.: US 2006/0042443 A1
(43) Pub. Date: Mar. 2, 2006

(54) Parallel fences for cutting devices

(75) Inventor: Yoshinori Shibata, Anjo-shi (JP)

Correspondence Address: OLIFF & BERRIDGE, PLC, P.O. BOX 19928, ALEXANDRIA, VA, 22320, US

(73) Assignee: MAKITA CORPORATION, Anjo-shi (JP)

(21) Appl. No.: 11/206,174

(22) Filed: Aug. 18, 2005

(30) Foreign Application Priority Data
Aug. 24, 2004 (JP) 2004-243661

(51) Int. Cl. B27B 27/04; B23D 19/00

(52) U.S. Cl. 83/477.2

(57) ABSTRACT

A parallel fence for determining a position of a workpiece on a table relative to a rotary cutting blade has a body support and a fence body. The body support is movable across the table in a direction along a rotational axis of the cutting blade. The body support has a support shaft that defines a pivotal axis. The fence body is supported by the body support and is pivotal within a plane about the pivotal axis of the support shaft. The fence body has a guide surface disposed on one side of the fence body opposing the cutting blade for contacting with the workpiece. The fence body can be adjusted about the pivotal support to ensure that the fence body is parallel to the rotary cutting blade.

This application claims priority to Japanese patent application serial number 2004-243661, the contents of which are incorporated herein by reference.

### BACKGROUND OF THE INVENTION

Field of the Invention

The present invention relates to parallel fences used for cutting devices, and in particular to fences for positioning workpieces (e.g., typically wooden workpieces) parallel to circular saw blades that protrude from upper surfaces of tables of cutting devices (called “table saws”), upon which the workpieces are placed.

U.S. Pat. No. 6,360,641 teaches general techniques relating to parallel fences used for table saws. In this kind of table saw, a table is supported on a base so as to be positioned at a level substantially corresponding to the height of a waist of an operator. A circular saw blade is disposed at a substantially central position of the table such that an upper portion of the saw blade protrudes upward from an upper surface of the table. Guide rails disposed on and extending along opposite sides of the table support a parallel fence so that the fence can move and remain parallel to the saw. The fence may be spaced above the upper surface of the table by a slight clearance. The fence can be fixed at any desired position by the rotational operation of a fixing lever.

However, in general, the accuracy of guide surfaces of the parallel fence with respect to the circular saw blade when the fence has been fixed in position may be lower if the price range of the parallel fence is relatively low. If the accuracy of the parallel fence is lower, it is difficult to precisely perform a cutting operation.

### SUMMARY OF THE INVENTION

It is accordingly an object of the present invention to teach improved parallel fences that can accurately position the parallel fences without an accompanying substantial increase in the manufacturing costs.

In one aspect of the present teachings, parallel fences for determining a position of a workpiece on a table relative to a rotary cutting blade, such as a circular saw blade, are located within a first plane substantially parallel to an upper surface of the table. The cutting blade may at least partially protrude upward from an upper surface of the table. The parallel fence may include a body support and a fence body. The body support is movable across the table in a direction along a rotational axis of the cutting blade while maintaining an orientation parallel to the cutting direction of the circular saw blade. The body support may have a support shaft that defines a pivotal axis. The fence body is supported by the body support and is pivotal within the first plane about the pivotal axis of the support shaft. The fence body has a guide surface disposed on one side of the fence body opposing the cutting blade for contacting with the workpiece.

Therefore, the parallel adjustment of the guide surface with respect to the cutting blade can be performed by adjusting the pivotal position of the fence body relative to the body support. As a result, the cutting operation can be accurately performed by a simple operation of a parallel fence having a simple construction, without causing an increase in the manufacturing cost, for example, in order to improve the accuracy of the support structure for the supporting of the fence body by the body support.

In one embodiment, the position of the pivotal axis of the support shaft is aligned with one of the points where the circumferential edge of the cutting blade intersects with a second plane that is parallel to an upper surface of the fence body, as viewed in the direction of the rotational axis of the cutting blade. With this arrangement, a measuring device, such as a measuring tape, can effectively perform the measurement of the distance between the guide surface and the cutting blade. In addition, by measuring the distance at the two intersecting points, the parallel adjustment can be more effectively performed.

In another embodiment, the parallel fence further includes a measuring device mounted to the fence body and operable to measure the distance between the guide surface of the fence body and the cutting blade. With this arrangement, the measurement of the distance can be easily and readily performed, further improving the operability of the parallel fence with respect to parallel adjustment. The measuring device may be a measuring rod, a measuring tape, or a distance sensor, for example.

In a further embodiment, the measuring device is movable relative to the fence body along a direction substantially perpendicular to the rotational axis of the cutting blade. Therefore, the distance between the guide surface and the cutting blade can be easily measured at two different positions by moving the measuring device. As a result, parallel adjustment can be even more easily performed.

In another aspect of the present teachings, parallel fences are taught that include a fence body and a measuring device. The fence body is movable, in a parallel orientation, over the table in a direction along a rotational axis of the cutting blade. A guide surface is disposed on one side of the fence body opposing to the cutting blade for contacting with the workpiece. The measuring device is mounted to the fence body and is operable to measure the distance between the guide surface of the fence body and the cutting blade.

With this arrangement, the distance between the guide surface of the fence body and the cutting blade can be easily measured without the operator needing to prepare a separate measuring device. In addition, it is possible to accurately make parallel adjustments by using the measuring device.

In a further aspect of the present teachings, cutting devices are taught that include a table, a rotary cutting blade, and a parallel fence. The cutting blade may at least partially protrude upward from an upper surface of the table. The parallel fence has a fence body that is movable relative to the table in a first direction along the rotational axis of the cutting blade and is pivotable about a pivotal axis within a plane substantially parallel to the upper surface of the table. The fence body defines a guide surface along which the workpiece is moved for a cutting operation. A first fixing device is operable to fix the fence body in position in the first direction. A second fixing device is operable to fix the fence body in position about the pivotal axis. Therefore, a parallel adjustment of the guide surface may be performed by pivoting the fence body about the pivotal axis and then fixing the fence body in position by the second fixing device.

### BRIEF DESCRIPTION OF THE DRAWINGS

FIG. 1 is a perspective view of a table saw incorporating a representative parallel fence; and

FIG. 2 is a plan view of the table saw; and

FIG. 3 is a front view as viewed from the side of a guide surface of a fence body of the parallel fence; and

FIG. 4 is a side view of the parallel fence; and

FIG. 5 is a cross sectional view taken along line (5)-(5) in FIG. 3 and showing a vertical sectional view of a pivotal support structure for supporting the fence body by a body support; and

FIG. 6 is a cross sectional view taken along line (6)-(6) in FIG. 3 and showing a vertical sectional view of the fence body; and

FIG. 7 is a cross sectional view taken along line (7)-(7) in FIG. 3 and showing a vertical sectional view of a fixing device for fixing the fence body in position relative to the body support; and

FIG. 8 is a plan view of a modification of a parallel fence incorporating a measuring tape; and

FIG. 9 is a front view of the modification shown in FIG. 8.

### DETAILED DESCRIPTION OF THE INVENTION

Each of the additional features and teachings disclosed above and below may be utilized separately or in conjunction with other features and teachings to provide improved parallel fences and cutting devices having such parallel fences. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

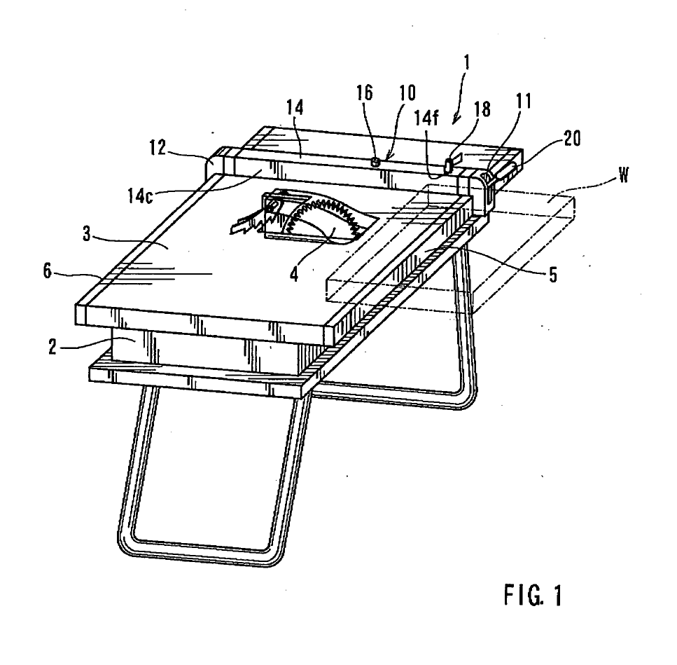

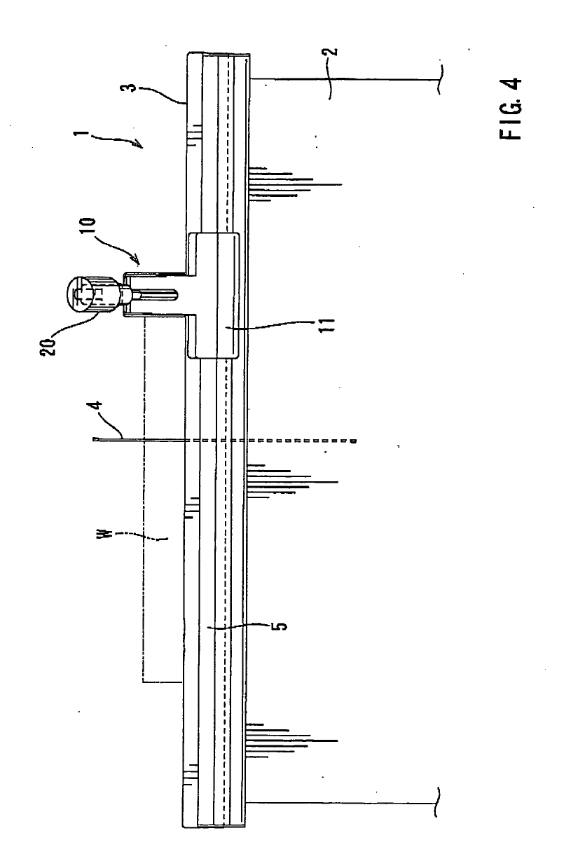

A representative embodiment of the present invention will now be described with reference to FIGS. 1 to 8. Referring to FIG. 1, a cutting device 1 incorporating a representative parallel fence 10 is shown. The construction of the cutting device 1 is the same as the known cutting device and will be described in brief.

The cutting device 1 has a base 2 and a table 3 mounted to the upper portion of the base 2. A circular saw blade 4 is disposed within the central portion of the table 3 such that an upper portion of the saw blade 4 extends upward from the upper surface of the table 3. A drive device (not shown), which may include a motor as a drive source, rotatably drives the circular saw blade 4. In order to perform a cutting operation, the operator may be positioned on the right side of the table 3 as viewed in FIG. 1. More specifically, the operator may place a workpiece W on the table 3 and then move the workpiece W in a leftward direction, as viewed in FIG. 1, in order to cut the workpiece W.

The parallel fence 10 is disposed on the right side as viewed from the perspective of the operator (upper side as viewed in FIG. 1) and may be used for positioning the workpiece W relative to the saw blade 4. Thus, the workpiece W may be positioned such that one side surface of the workpiece W contacts with the parallel fence 10. The operator may then move the workpiece W along the parallel fence 10 for a parallel translation of the workpiece W during the cutting operation.

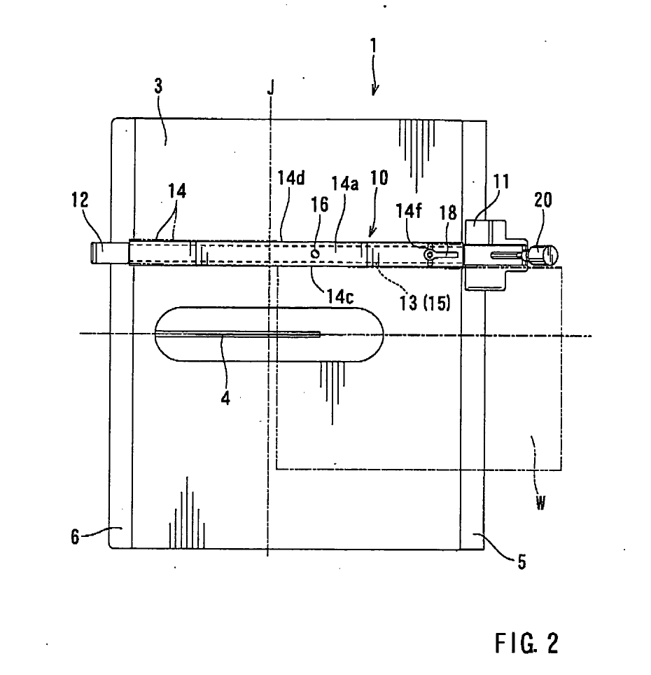

The parallel fence 10 includes a fence body 14 and a body support 15 (see FIG. 2). The table 3 supports the body support 15 such that the body support 15 can make parallel translation movements within a plane parallel to the upper surface of the table 3. The fence body 14 is supported by the body support 15 such that the fence body 14 can move with the body support 15 in a diction parallel to the table 3.

A pair of guide rails 5 and 6 is mounted to the front end and the rear end as viewed from the side of the operator (the right end and the left end as viewed in FIG. 1) of the table 3. The guide rails 5 and 6 extend parallel to each other and also parallel to a rotational axis J of the saw blade 4 (see FIG. 2). The guide rails 5 and 6 respectively slidably support the front end and the rear end of the body support 15.

Although not shown in the drawings, a scale may be mounted to the upper surface of the table 3 in a position proximate to the front guide rail 5, which is positioned nearer to the operator.

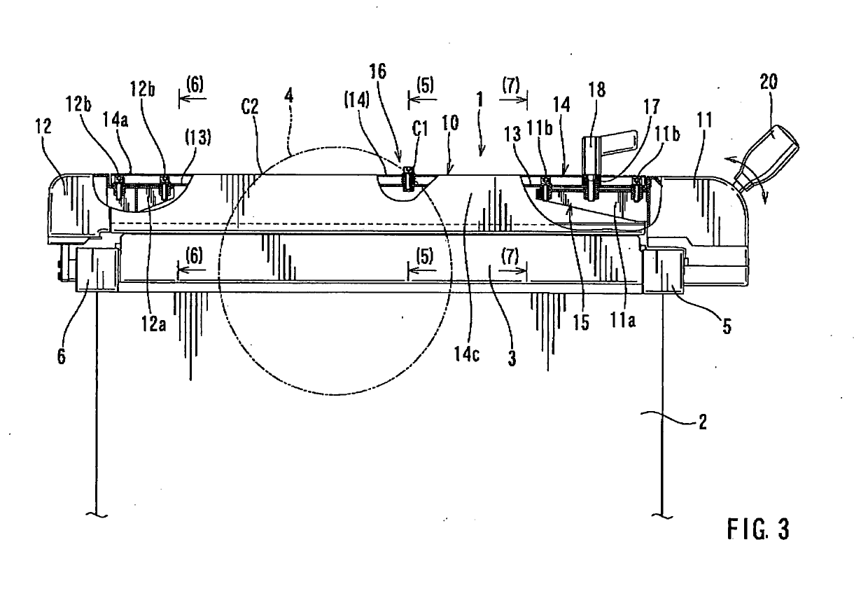

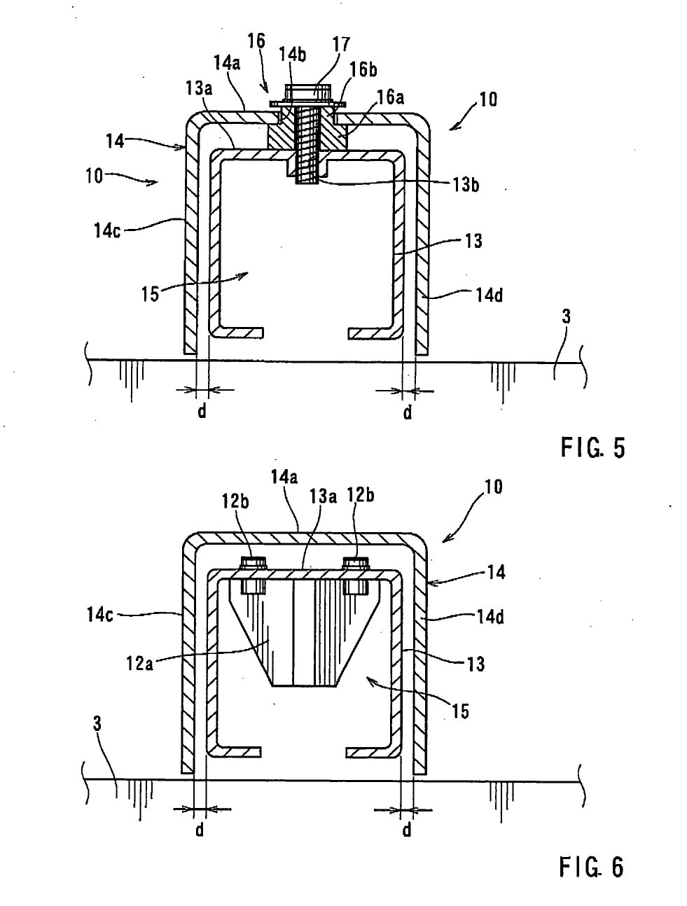

The body support 15 includes a front support base 11 and a rear support base 12 respectively slidably joined to the front guide rail 5 and the rear guide rail 6. The body support 15 also includes a joint frame 13 connecting the front support base 11 to the rear support base 12. As shown in FIG. 3, the front and rear support bases 11 and 12 respectively have joint portions 11a and 12a extending inwardly toward each other. As shown in FIGS. 5 to 7, the joint fame 13 is configured to have a substantially rectangular tabular configuration with an opened lower side. The joint portions 11a and 12a are respectively inserted into opposite end portions of the joint frame 13. Consequently, the opposite end portions of the joint frame 13 rest on the joint portions 11a and 12a. With the opposite end portions of the joint frame 13 thus resting on the joint portions 11a and 12a, the opposite end portions of the joint frame 13 are respectively secured to the joint portions 11a and 12a by fixing bolts 11b and fixing bolts 12b. In this way, the joint frame 13 is fixed in position relative to the front and rear support bases 11 and 12 so as to extend therebetween over the table 3, while the joint frame 13 is spaced a small distance above the upper surface of the table 3.

As shown in FIGS. 5 to 7, the fence body 14 has a substantially inverted U-shaped configuration so as to extend along the opposing side surfaces and the upper surface of the joint frame 13. The fence body 14 essentially covers the joint frame 13 over substantially the entire length (in the right and left directions as viewed in FIGS. 2 and 3) of the joint frame 13. Opposing side surfaces 14c and 14d of the fence body 14 are respectively spaced from the opposing side surfaces of the joint frame 13 by predetermined clearances d in the widthwise direction. As will be described later, the fence body 14 can pivot within a horizontal plane relative to the joint fame 14 within a range permitted by the clearances d.

A support shaft 16 is mounted to the joint frame 13 at a substantially central portion with respect to the length. The support shaft 16 supports the fence body 14 such that the fence body 14 can pivot within a horizontal plane about the axis of the support shaft 16. The details of the support shaft 16 are shown in FIG. 5.

More specifically, the axis of the support shaft 16 or the pivotal axis of the fence body 14 is set to be aligned, as viewed in the direction of the rotational axis J of the saw blade 4, with one of points C1 and C2 (the point C1 is used in this representative embodiment, as seen in FIG. 3) where the circumferential edge of the saw blade 4 intersects with a horizontal plane parallel to the upper surface of an upper portion 14a of the fence body 14. Thus, the points C1 and C2 are spaced apart from each other in a direction perpendicular to the rotational axis J of the saw blade 4.

As shown in FIG. 5, the support shaft 16 may have a large diameter portion 16a coaxial with a small diameter portion 16b. The large diameter portion 16a is positioned between the upper portion 14a of the fence body 14 and an upper portion 13a of the joint frame 13 in order to keep a predetermined space between the upper portions 14a and 13a. The small diameter portion 16b continues from the large diameter portion 16a via a stepped portion and is rotatably inserted into a support hole 14b formed in the upper portion 14a of the fence body 14. Therefore, the fence body 14 is supported by the upper portion 13a of the joint frame 13 via the support shaft 16 (i.e., the small diameter portion 16b), so that the fence body 14 can pivot within a horizontal plane. A fixing bolt 17 is inserted into an axial hole 16c formed in the support shaft 16 and engages with a threaded hole 13b formed in the upper portion 13a of the joint frame 13. Therefore, the support shaft 16 may be fixed in position relative to the upper portion 13a of the joint frame 13 by tightening the fixing body 17 into the threaded hole 13b. As for opposing side portions 14c and 14d the side portion 14c on the side of the saw blade 4 defines a guide surface contacted by the workpiece W during the cutting operation.

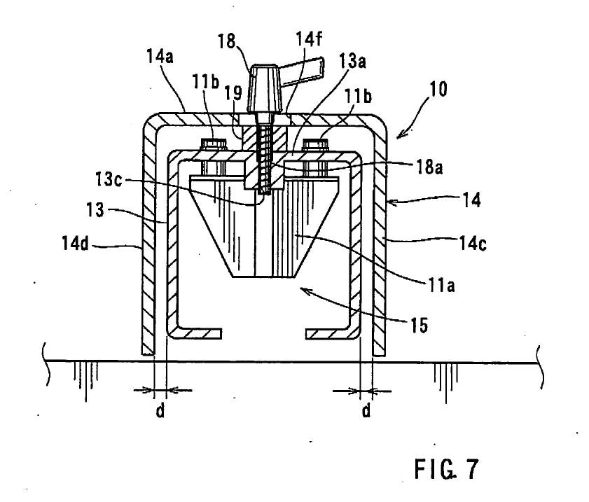

The pivotal position of the fence body 14 relative to the body support 15 may be fixed by the tightening operation of a fixing lever 18. As shown in FIG. 7, the fixing lever 18 has a threaded shaft 18a that extends through an insertion hole 14f formed in the upper portion 14a of the fence body 14. The threaded shaft 18a engages with a threaded hole 13c formed in the upper portion 13a of the joint frame 13. The insertion hole 14f is elongated along an arc of a circle with respect to the axis of the support shaft 16. A spacer 19 is fitted on the threaded shaft 18a so as to be interposed between the upper portion 14a of the fence body 14 and the upper portion 13a of the joint frame 13. The spacer 19 has a thickness (i.e., the height in the vertical direction as viewed in FIG. 7) that is substantially the same as the thickness or the height of the large diameter portion 16a of the support shaft 16. Therefore, the upper portion 14a of the fence body 14 is held substantially in parallel to the upper portion 13a of the joint frame 13 by the spacer 19 and the large diameter portion 16a. The insertion hole 14f is elongated in the right and left directions as viewed in FIG. 7 and has a width that is smaller than the outer diameter of the fixing lever 18 and the outer diameter of the spacer 19.

In order to permit pivotal movement of the fence body 14 about the support shaft 16 within a plane parallel to the upper surface of the table 3, the operator may rotate the fixing lever 18 in the loosening direction with respect to the nut 13c. By pivoting the fence body 14 about the support shaft 16, the guide surface 14c may be adjusted to be parallel to the saw blade 4. With the guide surface 14c held parallel to the saw blade 4 by the adjusting operation, the operator may then rotate the fixing lever 18 in the tightening direction so that the fence body 14 may be fixed in position relative to the body support 15.

After completion of the position adjusting operation and the fixing operation of the fence body 14, the operator may place the workpiece W on the upper surface of the table 3. The operator can accurately perform a cutting operation of the workpiece W by moving the workpiece W so as to slide along the guide surface 14c.

An operation handle 20 is mounted on the front support base 11 on the side of the operator and is vertically pivotally movable relative to the front support base 11, as indicated by arcuate opposing arrows in FIG. 3. The operation handle 20 is coupled to switching devices disposed within the front and rear support bases 11 and 12. The switching devices may permit the movement of the support bases 11 and 12 relative to the guide rails 5 and 6 and they may fix the support bases 11 and 12 in a position relative to the guide rails 5 and 6, when the operation handle 20 is respectively positioned at a releasing position and a fixing position. In addition, the switching devices may permit the removal of the entire parallel fence 10 through disengagement of the guide rail 6 from the support base 12 when the operation handle 20 is at a removing position with respect to the vertical direction. Such switching devices are well known in the parallel fence field and as a result will not be described in detail.

Therefore, in order to perform a cutting operation, the operator may first position the operation handle 20 at a releasing position and moves the entire parallel fence 10 along the guide rails 5 and 6 to a target position. The operator may then pivot the operation handle 20 to the fixing position so that the support bases 11 and 12 may be fixed in position relative to the guide rails 5 and 6.

Thereafter, the operator may loosen the fixing lever 18 to enable pivotal movement of the fence body 14 within a horizontal plane. The operator then pivots the fence body 14 to orient the guide surface 14c parallel to the saw blade 4. For example, such parallel adjustment may be performed by measuring the distance between the guide surface 14c and the saw blade 4 at two or more positions for verifying the equivalency of the measured values. After the parallel adjustment, the operator may rotate the fixing lever 18 in the tightening direction so that the fence body 14 may then be fixed in position relative to the body support 15.

In this way, according to the representative embodiment, the parallel position of the guide surface 14c relative to the saw blade 4 can be easily adjusted by a simple operation. In addition, for example, in comparison with the adjustment of the body support 15 relative to the table 3, it is possible to accurately and reliably position the guide surface 14c to be parallel to the saw blade 4. Consequently, it is possible to perform highly accurate cutting operations. Therefore, the representative parallel fence 10 can be especially advantageously applied to the lower price range of cutting devices.

Further, according to this representative embodiment, the pivotal axis of the fence body 14 or the rotational axis of the support shaft 16 is positioned to be aligned with the point C1, where the circumferential edge of the saw blade 4 intersects with a horizontal plane parallel to the upper surface of an upper portion 14a of the fence body 14. This arrangement is advantageous in order to measure the distance between the guide surface 14c and the saw blade 4 at two or more positions for verifying the equivalency of the measured values.

For example, in the case where the pivotal axis of the fence body 14 is positioned at a central position between the points C1 and C2, there is a possibility that the head 17 of the support shaft 16 may interfere with the operation for measuring the distance using a measuring device, such as a measuring rod.

Further, in case where the pivotal axis of the fence body 14 is positioned between the point C1 and the front end of the fence body 14 on the side of the operator, or in case that the pivotal axis of the fence body 14 is positioned between the point C2 and the rear end of the fence body 14 on the side away from the operator, all of the measured values at the two or more positions where the fence body 14 opposes to the saw blade 4 (such as the points C1 and C2) may vary as the pivotal position of the fence body 14 changes. Thus, it is necessary to measure all of the distances at two or more positions after each adjusting operation. Therefore, it takes much time in order to make a fine adjustment.

Thus, in order to accurately and reliably measure the distance between the guide surface 14c and the saw blade 4 at two or more positions for verifying the coincident of the measured values while ensuring a sufficient distance between the measuring points, it is preferable that the pivotal axis of the fence body 14 is chosen to be aligned with the point C1 or the point C2.

Furthermore, as shown in FIG. 3, the saw blade 4 may preferably be positioned at a position farther from the side of the operator than the central position with respect to the forward and rearward directions (right and left directions as viewed in FIG. 3) of the table 3. With this arrangement, the point C1 may be positioned proximally to the central position of the table 3 so that the moving distance of the end portions of the fence body 14 during the adjusting operation can be minimized without an increase in the size of the cutting device 1.

Consequently, with the placement of the pivotal axis of the fence body 14 at the point C1, the pivotal axis may not interfere with the measuring device, such as a measuring rod, even in the event that the measuring device is used to measure the distance at positions between the points C1 and C2. In addition, the size of the cutting device 1 will not increase. Further, once the operator measures the distance between the guide surface 14c and the saw blade 4 at the point C1, it is not necessary to re-measure the distance at the point C1, since the distance at the point C1 may not vary independently of the pivoted position of the fence body 14. Therefore, it is only necessary to measure the distance at another position for a parallel adjustment. As a result, the adjusting operation can be easily and quickly performed.

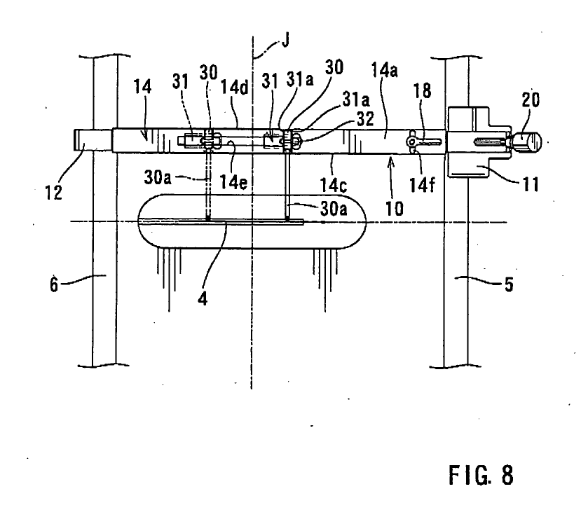

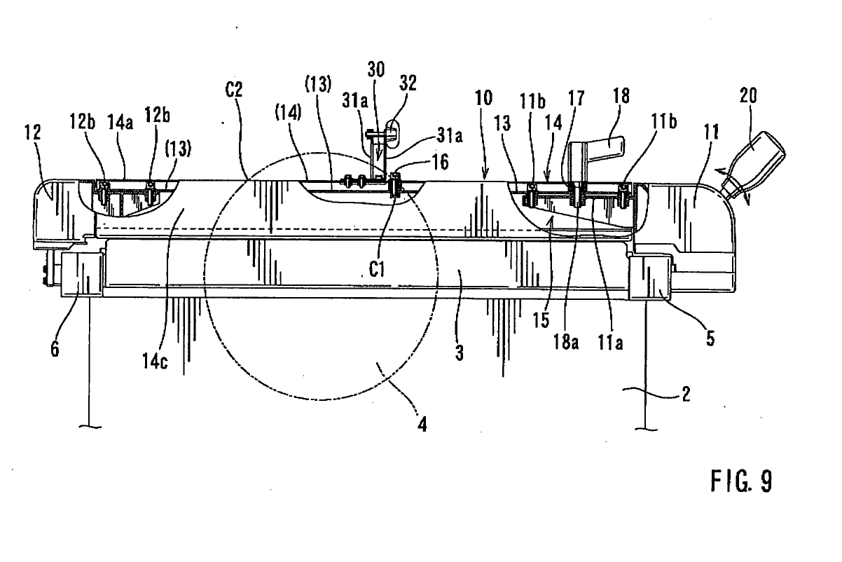

The present invention may not be limited to the above representative embodiment but may be modified in various ways. FIGS. 8 and 9 show a modification that is different from the above representative embodiment in the incorporation of a measuring device 30 mounted to the upper portion 14a of the fence body 14 and the construction relating to the measuring tape 30. The other construction is the same as in the above representative embodiment. Therefore, in FIGS. 8 and 9, like members are given the same reference numerals as in FIGS. 1 to 7 and the description of these members may not be repeated.

Referring to FIG. 8, a bracket 31, which is mounted to the upper portion 14a of the fence body 14, supports the measuring device 30. The bracket 31 has a pair of upright members 31a in order to hold a measuring device 30 therebetween. A fixing screw 32 extends between the upper portions of the upright members 31a and is operable to adjust the relative distance between the upright members 31a. Therefore, when the operator rotates the fixing screw 32 in one direction, the upright members 31a may move away from each other so that the measuring device 30 can be removed from or can be set between the upright members 31a. On the contrary, when the operator rotates the fixing screw 32 in an opposite direction, the upright members 31a may move toward each other causing the measuring device 30 to be clamped and held between the upright members 31a.

The measuring device 30 includes a case 30b and a measuring tape 30a coiled within the case 30b and having a length scale marked thereon. The measuring tape 30a may be withdrawn from the case 30b and may retreat into the case 30b as in a known measuring device utilizing a measuring tape. In other words, a commercially available measuring device utilizing a measuring tape can be used as the measuring device 30 of this modification. In order to measure the distance between the saw blade 4 and the guide surface 14c with the case 30b held between the upright members 31a, the measuring tape 30a may be withdrawn from the case 30b until the front end of the measuring tape 30a contacts with the saw blade 4. The operator may then read the indicated length value on the length scale of the measuring tape 30a.

Further, in this modification the bracket 31 is mounted to the upper portion 14a of the fence body 14 such that the bracket 31 can move along an elongated slot 14e formed in the upper portion 14a in the longitudinal direction (i.e., the forward and rearward directions of the fence body 14). Therefore, by moving the bracket 31 along the elongated slot 14e, it is possible to measure the distance between the saw blade 4 and the guide surface 14c at two or more positions in the forward and rearward directions, such as the positions indicated by solid lines and chain lines in FIG. 8. For example, with the bracket 31 held in a position indicated by the solid lines, the operator may withdraw the measuring tape 30a from the case 30b until the front end of the measuring tape 30a contacts with the side surface of the saw blade 4. The operator may lock or hold the measuring tape 30a at the withdrawn position and may subsequently move the bracket 31 to the position indicated by the chain lines. If the front end of the measuring tape 30a does not contact with the side surface of the saw blade 4 or if the measuring tape 30a buckles while the front end contacts with the side surface of the saw blade 4, the operator may make a parallel adjustment of the fence body 14 until the front end of the measuring tape 30a contacts with the side surface of the saw blade 4 without causing the buckling or flexing of the measuring tape 30a. After the parallel adjustment, the operator may tighten the fixing lever 18 in order to fix the fence body 14 in a position relative to the body support 15.

For parallel adjustments, it is preferable to use the reading of the indicated value of the length scale on the measuring tape 30a, so that the guide surface 14c of the fence body 14 can be further accurately positioned parallel to the saw blade 4.

In addition, the position of the body support 13 or the entire parallel fence 10 relative to the saw blade 4 may be determined by utilizing the measuring device 30. Thus, in order to position the body support 13, the operator may first move the operation lever 20 to the release position. The operator may then move the body support 13 or the entire parallel fence along the rails 5 and 6, while referencing the readings of the measuring tape 30a.

In this way, the measuring device 30 can be used for determining the parallel position of the fence body 14 and can also be used for determining the position of the body support 13 or the entire parallel fence 10 relative to the saw blade 4.

The measuring device 30 may be replaced with any other measuring device as long as the device can measure the distance between the guide surface 14c and the saw blade 4. For example, the measuring device 30 may be an ordinary measuring rod or may be a distance sensor that can display the measured distance as a numerical value.

This invention claims:

1. A parallel fence for determining a position of a workpiece on a table relative to a rotary cutting blade, which at least partially protrudes upward from an upper surface of the table, within a first plane substantially parallel to an upper surface of the table, comprising:
a body support movable in parallel along the table in a direction along a rotational axis of the rotary cutting blade and having a support shaft, wherein the support shaft defines a pivotal axis; and
a fence body supported by the body support and pivotal within the first plane about the pivotal axis of the support shaft, wherein the fence body has a guide surface disposed on one side of the fence body opposing the rotary cutting blade for contacting with the workpiece.

2. The parallel fence as in claim 1,
wherein the pivotal axis of the support shaft is positioned to be aligned with a point where the circumferential edge of the rotary cutting blade intersects with a second plane that is parallel to an upper surface of the fence body, as viewed in the direction along a rotational axis of the rotary cutting blade.

3. The parallel fence as in claim 1,
further comprising a measuring device mounted to the fence body and operable to measure the distance between the guide surface of the fence body and the rotary cutting blade.

4. The parallel fence as in claim 3,
wherein the measuring device is movable relative to the fence body along a direction substantially perpendicular to the rotational axis of the rotary cutting blade.

5. A parallel fence for determining a position of a workpiece on a table relative to a rotary cutting blade, which partially protrudes upward from an upper surface of the table, within a first plane substantially parallel to an upper surface of the table, comprising:
a fence body movable across the table in a direction along a rotational axis of the rotary cutting blade and having a guide surface disposed on one side of the fence body opposing to the rotary cutting blade for contacting with the workpiece; and
a measuring device mounted to the fence body and operable to measure the distance between the guide surface of the fence body and the rotary cutting blade.

6. The parallel fence as in claim 5,
wherein the measuring device is movable relative to the fence body along a direction substantially perpendicular to the rotational axis of the rotary cutting blade.

7. The parallel fence as in claim 5,
wherein the measuring device is removably mounted to the fence body.

8. A cutting device comprising:
a table having an upper surface;
a rotary cutting blade at least partially protruding upward from an upper surface of the table and having a rotational axis; and
a parallel fence comprising a fence body movable relative to the table in a first direction along the rotational axis of the cutting blade and pivotable about a pivotal axis within a first plane substantially parallel to the upper surface of the table, wherein the fence body defines a guide surface along which the workpiece is moved for a cutting operation;
a first fixing device arranged and constructed to fix the fence body in position in the first direction; and
a second fixing device arranged and constructed to fix the fence body in position about the pivotal axis.

9. The cutting device as in claim 8,
wherein the parallel fence further comprising a body support mounted on the upper surface of the table and movable relative to the table in the first direction; and
wherein the fence body is pivotally mounted to the body support, so that the fence body is pivotable about the pivotal axis; and
wherein the first fixing device is further arranged and constructed to fix the body support in position relative to the table in the first direction; and
wherein the second fixing device is further arranged and constructed to fix the fence body in position relative to the body support about the pivotal axis.

10. The cutting device as in claim 9,
further comprising a pair of guide rails mounted to the upper surface of the table and extending in a direction parallel to the first direction;
wherein the body support is slidably movable along the guide rails.

11. The cutting device as in claim 8,
wherein the fence body has a length in a direction substantially perpendicular to the first direction; and
wherein the pivotal axis is positioned in a substantially central location along the length of the fence body; and
wherein the second fixing device is positioned proximally to one end of the fence body along the length of the fence body.

12. The cutting device as in claim 8,
wherein the pivotal axis is positioned to be aligned, as viewed in the direction of the rotational axis of the cutting blade, with a point where the circumferential edge of the cutting blade intersects with a second plane that is parallel to an upper surface of the fence body.

13. The cutting device as in claim 12,
wherein the cutting blade is displaced from a central axis of the table with respect to the direction perpendicular to the first direction, so that the pivotal axis of the fence body is positioned substantially on the central axis of the table.

14. The cutting device as in claim 8,
further comprising a measuring device mounted to the fence body and operable to measure the distance between the guide surface of the fence body and the cutting blade.

15. The cutting device as in claim 14,
wherein the measuring device is movable relative to the fence body along a direction substantially perpendicular to the rotational axis of the rotary cutting blade.

16. The parallel fence as in claim 14,
further comprising a bracket arranged and constructed to removably hold the measuring device against the fence body; and
wherein the measuring device comprises a case and a measuring tape coiled within the case and having a length scale marked thereon, so that the measuring tape can be withdrawn from the case in order to measure the distance between the guide surface of the fence body and the cutting blade.
